(19) United States
(12) Patent Application Publication
(10) Pub. No.: US 2026/0181674 A1
(43) Pub. Date: Jun. 25, 2026

(54) METHODS, DEVICES AND MEDIUM FOR COMMUNICATION

(71) Applicant: NEC Corporation, Tokyo (JP)

(72) Inventors: Zhaobang MIAO, Beijing (CN); Gang WANG, Beijing (CN)

(73) Assignee: NEC Corporation, Tokyo (JP)

(21) Appl. No.: 19/126,338

(22) PCT Filed: Nov. 2, 2022
(86) PCT No.: PCT/CN2022/129334

§ 371 Date: May 1, 2025

(51) Int. Cl. H04W 72/25

(52) U.S. Cl. CPC H04W 72/25

(57) ABSTRACT

Example embodiments of the present disclosure relate to a method of communication, a terminal device and a computer readable medium. The method comprises: performing, at a first terminal device, a first transmission of a transport block with a second terminal device, the first transmission starting from a first starting position; and performing a second transmission of the transport block with the second terminal device, the second transmission starting from a second starting position determined based on the first starting position.

Example embodiments of the present disclosure generally relate to the field of communication techniques and in particular, to methods, devices, and medium for transport block (TB) multiple transmissions.

### BACKGROUND

With developments of communication technologies, terminal devices can perform direct communication with each other by setting up a sidelink therebetween and utilizing unlicensed spectrum.

Channel access mechanisms from New Radio Unlicensed (NR-U) are proposed to be reused for sidelink unlicensed operations. If the existing NR-U channel access framework does not support the required Sidelink-Unlicensed (SL-U) functionality, appropriate recommendations need to be made. Regarding the physical channel design framework, changes are required to NR sidelink physical channel structures and procedures to operate on unlicensed spectrum.

### SUMMARY

In general, embodiments of the present disclosure provide methods, devices and computer storage medium for TB multiple transmissions.

In a first aspect, there is provided a communication method. The method comprises: performing, at a first terminal device, a first transmission of a transport block with a second terminal device, the first transmission starting from a first starting position; and performing a second transmission of the transport block with the second terminal device, the second transmission starting from a second starting position determined based on the first starting position.

In a second aspect, there is provided a communication method. The method comprises: determining, at a first terminal device, a starting position for a transmission of a transport block from a set of candidate positions, the set of candidate positions being determined based on a plurality of demodulation reference signal (DMRS) patterns for the transmission; and performing the transmission from the starting position.

In a third aspect, there is provided a communication method. The method comprises: determining, at a first terminal device, a target DMRS pattern from a group of DMRS patterns, the group of DMRS patterns being determined based on at least one candidate position for a transmission of a transport block between the first terminal device and the second terminal device; and performing the transmission based on the target DMRS pattern.

In a fourth aspect, there is provided a communication method. The method comprises: determining, at a first terminal device, resource occupation information of a plurality of transmission occasions, wherein information on resource occupation of a first transmission occasion of the plurality of transmission occasions is determined based a scaling factor, the scaling factor being associated with a starting position of a transmission in the first transmission occasion or a preconfigured value; and determining a channel parameter based on the resource occupation information.

In a fifth aspect, there is provided a first terminal device. The first terminal device comprises at least one processor; and at least one memory coupled to the at least one processor and storing instructions thereon, the instructions, when executed by the at least one processor, causing the first terminal device to perform the method according to the first, second, third, or fourth aspect.

In a sixth aspect, there is provided a computer readable medium having instructions stored thereon, the instructions, when executed on at least one processor, causing the at least one processor to carry out the method according to the first, second, third, or fourth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling flow of TB transmissions in accordance with some embodiments of the present disclosure;

FIG. 3 illustrates a flowchart of a method implemented at a first terminal device according to some example embodiments of the present disclosure;

FIGS. 4A to 4B illustrate schematic diagrams of example TB transmissions in accordance with some embodiments of the present disclosure;

FIGS. 5A to 5D illustrate schematic diagrams of time domain resource reservation in accordance with some embodiments of the present disclosure;

FIG. 6 illustrates a flowchart of a method implemented at a first terminal device according to some example embodiments of the present disclosure;

FIG. 7 illustrates a schematic diagram of resource occupation in accordance with some embodiments of the present disclosure;

FIG. 8 illustrates a flowchart of a method implemented at a first terminal device according to some example embodiments of the present disclosure;

FIG. 9 illustrates a schematic diagram of resource occupation in accordance with some other embodiments of the present disclosure;

FIG. 10 illustrates a schematic diagram of automatic gain control (AGC) and DRMS transmission in accordance with some other embodiments of the present disclosure;

FIG. 11 illustrates a flowchart of a method implemented at a first terminal device according to some example embodiments of the present disclosure;

FIG. 12 illustrates a schematic diagram of sidelink channel occupancy ratio (CR) measurement in accordance with some embodiments of the present disclosure;

FIG. 13 illustrates a schematic diagram of sidelink channel busy ratio (CBR) measurement in accordance with some embodiments of the present disclosure; and

FIG. 14 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The “terminal device” can further has “multicast/broadcast” feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As discussed above, since existing NR-U channel access framework may not support all the required SL-U functionality, some changes need to be made. For example, maximum 2 candidate start symbols within a slot is proposed to be supported for a Physical Sidelink Control Channel (PSCCH)/Physical Sidelink Shared Channel (PSSCH) transmission, and thus there is a need for a unified design for PSCCH/PSSCH transmission from first or second start symbol. Furthermore, whether two or more candidate start symbols are also supported for slots with Physical Sidelink Feedback Channel (PSFCH) needs to be studied. Still further, there may be needs to study more issues related to, for example, but not limited to, Transport Block Size (TBS) determination when two ore more (re-)transmissions of a same TB start from different start symbols, DMRS symbol impacted by the second start symbol which is used for AGC, CR and CBR measurement for transmissions start from the second start symbol, reservation behavior on Sidelink Control Information (SCI)/PSCCH in the second start symbol, PSSCH symbol not enough from second start symbol if the slot contains PSFCH symbols, and so on.

To solve the above and other potential problems, embodiments of the present disclosure propose a mechanism supporting two or more starting positions for transmission/retransmission of a TB. In the proposed solutions, a first transmission of a TB on a sidelink starts from a first starting position, and a second transmission of the same TB starts from a second starting position determined based on the first starting position. In this way, two or more transmissions of the TB from different starting positions can be well supported.

Embodiments of the present disclosure also propose several mechanisms for solving issues related to DMRS transmission, resource occupation, and the like. Principles and implementations of the present disclosure will be described in detail below with reference to the figures.

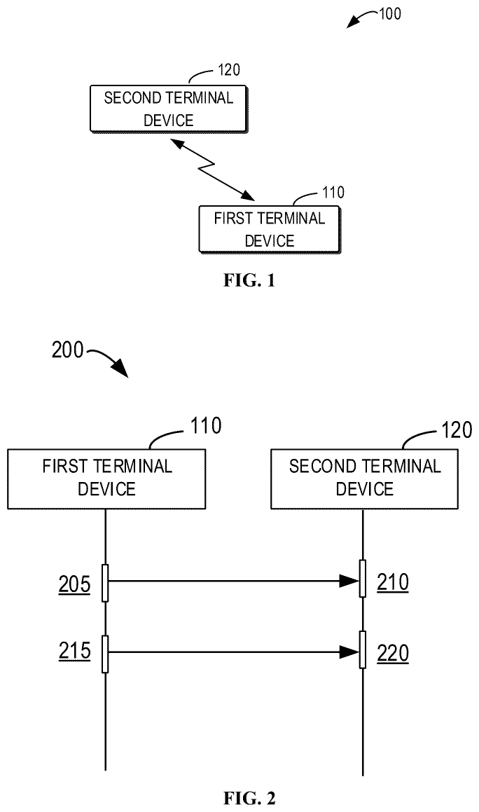

FIG. 1 illustrates a schematic diagram of an example communication environment 100 in which example embodiments of the present disclosure can be implemented. In the communication environment 100, a plurality of communication devices, including a first terminal device 110 and a second terminal device 120, can communicate with each other.

In the example of FIG. 1, the first terminal device 110 may be a UE and the second terminal device 120 may be another UE which is communicating or is to communicate with the first terminal device 110 through a sidelink.

It is to be understood that the number of devices and their connections shown in FIG. 1 are only for the purpose of illustration without suggesting any limitation. The communication environment 100 may include any suitable number of devices configured to implementing example embodiments of the present disclosure. It is noted that although illustrated as a UE, the first terminal device 110 or the second terminal device 120 may be other terminal device than a UE.

In the following, for the purpose of illustration, some example embodiments are described with the first terminal device 110 operating as a UE and the second terminal device 120 operating as another UE. In some example embodiments, operations described in connection with the first terminal device 110 may be implemented at the second terminal device 120, and operations described in connection with the second terminal device 120 may be implemented at first terminal device 110.

In some example embodiments, the first terminal device 110 and the second terminal device 120 communicates with each other on a sidelink (SL). Either the first terminal device 110 or the second terminal device 120 may act as a transmitting (TX) device (or a transmitter). If the first terminal device 110 is a TX device or a transmitter, the second terminal device 120 acts as a receiving (RX) device (or a receiver). Likewise, if the second terminal device 120 is a TX device or a transmitter, the first terminal device 110 acts as a RX device or a receiver.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Reference is made to FIG. 2, which illustrates a signaling flow 200 of TB transmissions in accordance with some embodiments of the present disclosure. For the purposes of discussion, the signaling flow 200 will be discussed with reference to FIG. 1, for example, by using the first terminal device 110 and the second terminal device 120.

In the embodiments of FIG. 2, the first terminal device 110 transmits (205) to the second terminal device 120 a first transmission of a TB starting from a first starting position. The first transmission may be an initial transmission of the TB or a retransmission of the TB. The second terminal device 120 receives (210) the first transmission from the first terminal device 110. The second terminal device 120 may provide feedback (for example, ACK/NACK) to the first terminal device 110 to indicate whether the TB has been received successfully.

If receiving a NACK feedback, the first terminal device 110 may be aware that the TB is not received successfully, and may decide to perform a retransmission of the TB. As shown in FIG. 2, the first terminal device 110 transmits (215), to the second terminal device 120, a second transmission of the TB at a second starting position, and the second terminal device 120 receives (220) the second transmission accordingly.

The second starting position is determined based on the first starting position. In some embodiments, there may be a set of candidates for a starting position. For example, the set of candidates may comprise, but not limited to, a first candidate position and a second candidate position, and the first candidate position is prior to the second candidate position. For example, the first candidate position is symbol 0 of a slot, and the second candidate position may be a symbol 7 of this slot.

In some cases, if the first transmission is an initial transmission of the transport block, the second transmission may be a retransmission of the transport block. As an alternatively, if the first transmission is a retransmission of the transport block, the second transmission may be a further retransmission of the transport block.

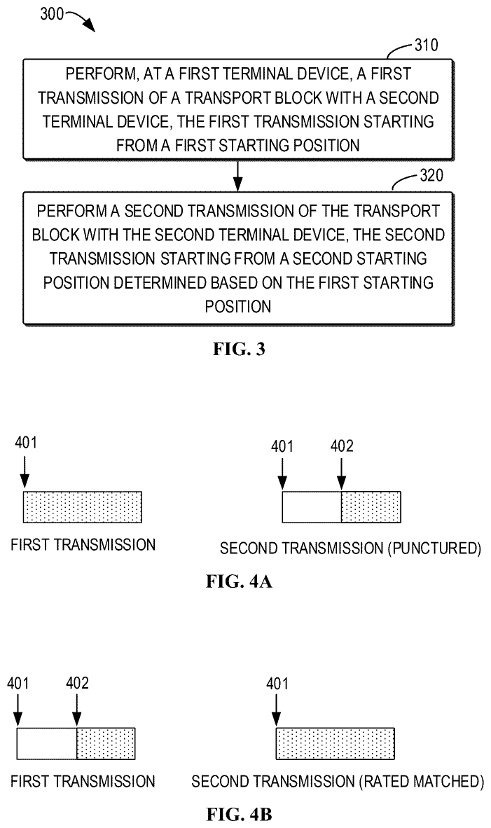

FIG. 3 illustrates a flowchart of a method 300 implemented at a first terminal device according to some example embodiments of the present disclosure. For the purpose of discussion, the method 300 will be described from the perspective of the first terminal device 110 in FIG. 1.

At block 310, the first terminal device 110 performs a first transmission of a transport block with the second terminal device 120. The first transmission starts from a first starting position.

At block 320, the first terminal device 110 a second transmission of the transport block with the second terminal device, the second transmission starting from a second starting position determined based on the first starting position.

It is to be understood that the first terminal device 110 may be either a transmitter or a receiver in the sidelink communication with the second terminal device 120. If, for example, the first terminal device 110 is a transmitter in the sidelink communication, the first terminal device 110 transmits the first transmission to the second terminal device 120 at block 310, and transmits the second transmission to the second terminal device 120 at block 320. Otherwise, if the first terminal device 110 is a receiver, it receives the first transmission from the second terminal device 120 at block 310 at block 310, and receives the first transmission from the second terminal device 120 at block 310 at block 310.

The size of the TB (also referred to as “TBS” hereafter) may be determined in various ways. In some example embodiments, the TBS may be determined based on a time length from the second candidate position to the end of a transmission occasion. For example, the transmission occasion may be a PSSCH duration, a slot, or some other time duration.

In some implementations, transmission occasion may be a slot comprising a plurality of symbols. In such cases, a staring position may be a symbol in the slot, which is also called as “start symbol” in some embodiments of the present disclosure.

For a TB's multiple transmissions, if a first transmission of the TB is start from the second start symbol in a slot n, the subsequent second transmission of the TB may use either the first (1^{st}) start symbols or the second start symbol in slot m. Both the first start symbols and the second start symbol are candidates for the starting positions in these implementations. In such cases, the first transmission may be an initial transmission or retransmission of the TB, the second transmission may be retransmission of the TB. The symbol number for calculating the TBS for the first and second transmissions may equal to the symbol length from second start symbol to the end of the PSSCH duration. This advantageously keeps consistent TBS for multiple transmissions of a same TB.

Alternatively, in some example embodiments, the TBS may be determined based on a time length from the first candidate position to the end of the transmission occasion excluding the second candidate position. The first starting position may be the first candidate position prior to the second candidate position.

In some implementations, for a TB's multiple transmissions, if a first transmission of the TB starts from the first start symbol in a slot n, the subsequent second transmission of the same TB may use the first start symbols in slot m. In this case, slot n and slot m may be within the same Channel occupancy time (COT). The first transmission may be an initial transmission or retransmission of the TB, and the second transmission may be retransmission of the TB. The symbol number for calculating TBS for the first and second transmissions may equal to the symbol length from first start symbol to the end of the PSSCH duration by deleting the second start symbol. This advantageously avoids different symbol length for multiple transmissions of a same TB.

As a further alternative, in some example embodiments, the TBS may be determined based on a predetermined time length. For example, the symbol number for calculating the TBS for the first and second transmissions may equal to a predefined value, for instance, M.

The predetermined time length may be, for example, a preconfigured value, which may be predefined by regulations, or may be received from a higher layer, for instance, via a RRC signaling. In some alternative embodiments, the predetermined time length may be determined by the first terminal device 110 and be indicated to the second terminal device 120 via, for example, a SCI signaling.

Alternatively, the predetermined time length may be an average value. The average value may indicate an average of a first time length from the first candidate position to the end of the transmission occasion (e.g., by deleting the second start symbol) and a second time length from the second candidate position to the end of the transmission occasion. By way of example, the average value may be an average value of a first symbol length starting from the first start symbol (e.g., symbol 0) to the last symbol of the slot and a second symbol length starting from the second start symbol (e.g., symbol 7) to the last symbol of the slot.

In some example embodiments, a difference between the first candidate position and the second candidate position is within a predefined range, for example, a predefined time range [Min, Max]. “Min” may indicate a minimum time length between the first candidate position and the second candidate position, and “Max” may indicate a maximum time length between the first candidate position and the second candidate position. In such cases, the first terminal device 110 may expect that the difference number between first and second start symbols should be within the range [Min, Max]; otherwise, the second start symbol may be disabled by the terminal device 110.

In the above cases, if the difference is larger than predefined Min, there may be enough time to perform channel access for the second start symbol of failed in first start symbol and decouple the channel states of first and second start symbols. If the difference is smaller than predefined Max, it can achieve a reasonable code rate for both of the first and second transmissions of the same TB.

In some example embodiments, if a time length of the second transmission is less than a time length of the first transmission, the second transmission is punctured.

FIGS. 4A to 4B illustrate schematic diagrams of example TB transmissions in accordance with some embodiments of the present disclosure. In the embodiments of FIG. 4A, it is assumed that, for a TB's multiple transmissions, the first transmission of a TB starts from a first candidate position 401, e.g., a first start symbol, and the second transmission of the TB starts from a second candidate position 402, e.g., a second start symbol. If the symbol length of the second transmission is less than the symbol length of the prior first transmission, the remaining data may be punctured for the second transmission. In such cases, the second transmission is a punctured transmission, which is a part of its intended transmission.

As an alternative, in some example embodiments, if a time length of the second transmission is larger than a time length of the first transmission, the second transmission is rate matched, for example, based on its intended transmission.

FIG. 4B shows such a situation where it is assumed that, for a TB's multiple transmissions, the first transmission of a TB starts from a second candidate position 402, e.g., a second start symbol, and the second transmission of the TB starts from a first candidate position 401, e.g., a first start symbol. Since the symbol length of the second transmission is larger than the symbol length of the prior first transmission, the remaining resource may be rate matched for the second transmission.

With regard to the two or more starting position mechanism, reservation and sensing behaviors on SCI/PSCCH in the second position, for example, the second start symbol, may also need to be discussed. In some example embodiments, if the first starting position is a second candidate position and the first transmission comprises a reservation indication, the reservation indication may indicate a subsequent reserved resource for a third transmission starting from the first candidate position which is prior to the second candidate position.

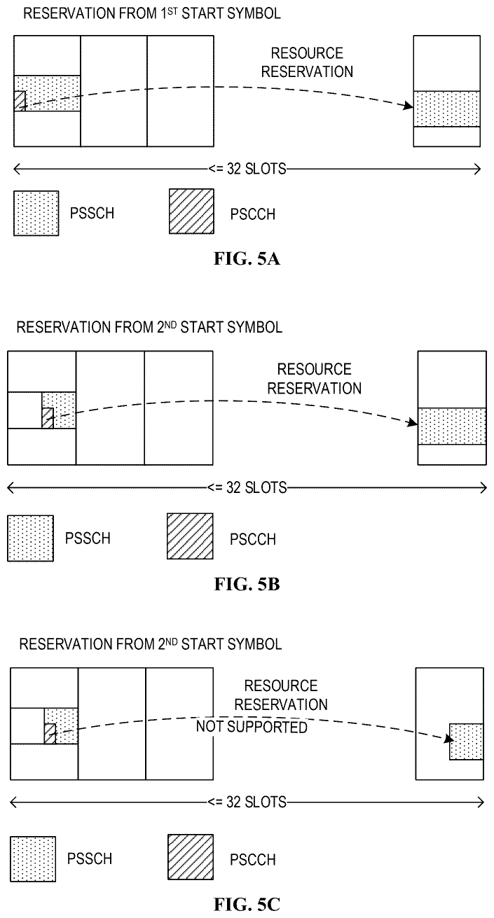

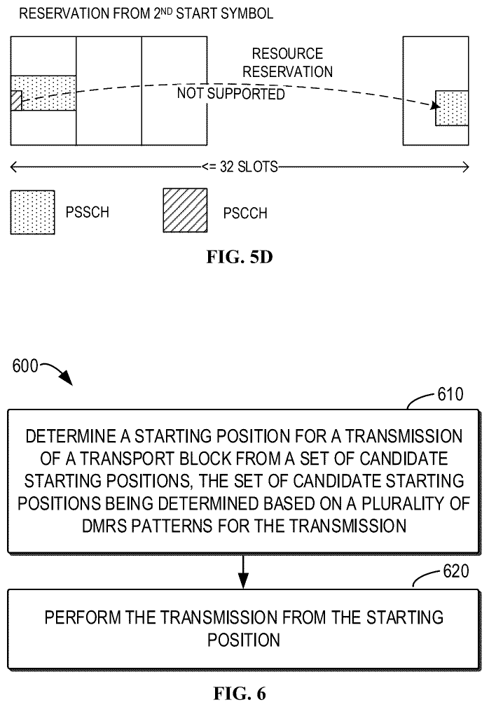

For the second start symbol, the interpretation (SCI monitoring/decoding and encoding) of time domain resource reservation in SCI may be consistent with reservation form the first start symbol. That is, the time domain resource reservation may always start from the first start symbol to the end of the slot (i.e., the whole slot). FIGS. 5A to 5D illustrate schematic diagrams of time domain resource reservation in accordance with some embodiments of the present disclosure. Specifically, FIGS. 5A to 5B show two scenarios that are supported according to embodiments of the present disclosure, and FIGS. 5C to 5D show further two scenarios that are not supported according to embodiments of the present disclosure.

In some situations, PSSCH symbol(s) may be not enough from the second start symbol if the slot contains PSFCH symbols. To address this issue, in some embodiments, in a resource pool, the second start symbol may be only configured/applied to a slot which is NOT configured with PSFCH symbols. As an alternative, the second start symbol may be disabled by the first terminal device 110 or the second terminal device 120 if the number of available PSSCH symbols is less than 7. In some example embodiments, if the first starting position is a second candidate position subsequent to the first candidate position, the first transmission does not have feedback from the second device 120.

As discussed above, the first and second starting positions may have a set of candidates comprising a first candidate position and a second candidate position, and the first candidate position may be prior to the second candidate position. In some example embodiments, a transmission staring from the second candidate position uses a second set of redundancy versions (RVs) different from a first set of redundancy versions used by a transmission staring from the first candidate position. That is, there may be different sets of redundancy versions corresponding to the first candidate position and the second candidate position. For example, a set of RVs, for example, {RV0, RV1, RV2 and RV3}, may be only used by a transmission starting from the first candidate position, and the RVs that could be used by a different transmission starting from the second candidate position should be a different set of RVs, for example, {RV0′, RV1′, RV2′ RV3′}.

In some scenarios, DMRS symbols may be impacted by the second start symbol which is used for AGC. In this regard, embodiments of the present disclosure propose solutions regrading, for example, but not limited to, defining of the second starting position to avoid the undesired impact, avoid of using some legacy DMRS patterns, AGC repetition around with DMRS RE, and so on.

FIG. 6 illustrates a flowchart of a communication method 600 implemented at a first terminal device in accordance with some embodiments of the present disclosure. For the purpose of discussion, the method 600 will be described from the perspective of the first terminal device 110 in FIG. 1.

At block 610, the first terminal device 110 determines a starting position for a transmission of a transport block from a set of candidate positions. The set of candidate positions is determined based on a plurality of DMRS patterns for the transmission.

Table 1 shows the plurality of DMRS patterns. Specifically, Table 1 defines PSSCH DMRS time-domain locations. As shown in Table 1, the DMRS patterns may include, for example, “3, 10”, “1, 6, 11”, “1, 4, 7, 10”, “4, 10”, “1, 5, 9”, and so on.

TABLE 1

| | DM-RS position l̅ | | | | | |
|---|---|---|---|---|---|---|
| | PSCCH duration 2 symbols | | | PSCCH duration 3 symbols | | |
| l_{d} in | Number of PSSCH DM-RS | | | Number of PSSCH DM-RS | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

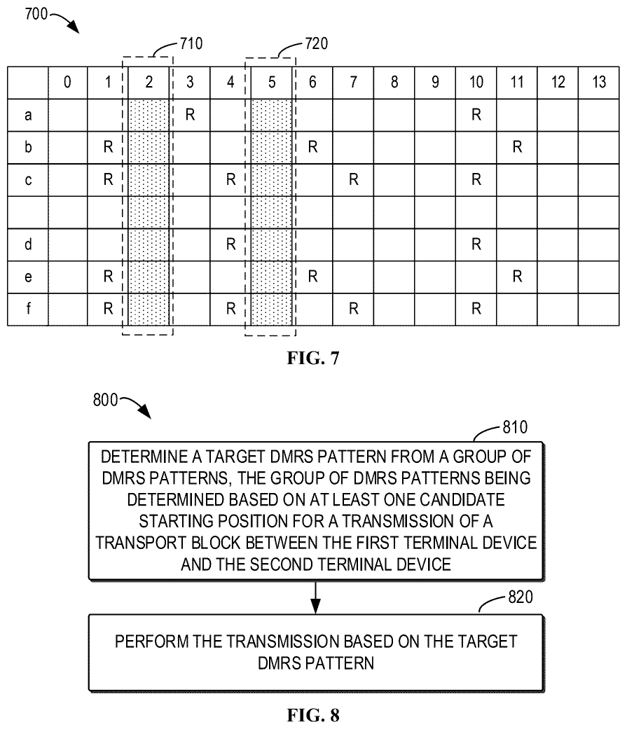

FIG. 7 illustrates a schematic diagram of resource occupation 700 in accordance with some embodiments of the present disclosure. As shown in FIG. 7, the first row lists the indices 0 to 13 of symbols in a slot. In embodiments of the present disclosure, one slot may comprise 14 symbols, namely, symbol 0, symbol 1, . . . , symbol 13. In FIG. 7, rows “a”, “b”, “c”, “d”, “e” and “f” each indicate an example slot. Each slot comprises 14 symbols, and some of them are occupied by DMRS transmission, as indicated by “R”. Specifically, the row “a” corresponds to the DMRS pattern “3, 10”, the row “b” corresponds to the DMRS pattern “1, 6, 11”, the row “c” corresponds to the DMRS pattern “1, 4, 7, 10”, and the row “d” corresponds to the DMRS pattern “4, 10”. It is to be understood that the above example rows and their corresponding DMRS patterns are illustrated for purpose of example, rather than suggesting any limitations. Other DMRS patterns can also be applicable to embodiments of the present disclosure.

According to the DMRS patterns defined in Table 1, the symbols occupied by DMRS transmissions may be determined and labelled by “R” in FIG. 7. It can be seen that the column 710 corresponding to symbol 2 and the column 720 corresponding to symbol 5 are totally unoccupied by the DMRS transmissions. So, in these embodiments, symbols 2 or 5 may be used as candidate positions for the starting position of a transmission.

Along this line, the set of candidate positions may comprise a position corresponding to symbol 2 and/or a position corresponding to symbol 5. For instance, at 610, the first terminal device 110 may determine the starting position for the transport block, for example, as the position corresponding to symbol 2. Alternatively, the first terminal device 110 may determine the starting position as the position corresponding to symbol 5.

At block 620, the first terminal device 110 performs the transmission from the starting position.

In this way, the DMRS for PSSCH transmission from the first start symbol will not be impacted by AGC in the second start symbol. As such, all the defined DMRS patterns can be fully reused.

FIG. 8 illustrates a flowchart of a communication method 800 implemented at a first terminal device in accordance with some embodiments of the present disclosure. For the purpose of discussion, the method 800 will be described from the perspective of the first terminal device 110 in FIG. 1.

At block 810, the first terminal device 110 determines a target DMRS pattern from a group of DMRS patterns. The group of DMRS patterns are determined based on at least one candidate position for a transmission of a transport block between the first terminal device and the second terminal device. At block 820, the first terminal device 110 performs the transmission based on the target DMRS pattern.

In some example embodiments, the group of DMRS patterns may be determined by removing at least one DMRS pattern from a plurality of DMRS patterns. Each of the at least one DMRS pattern may have DMRS transmission in the at least one candidate position.

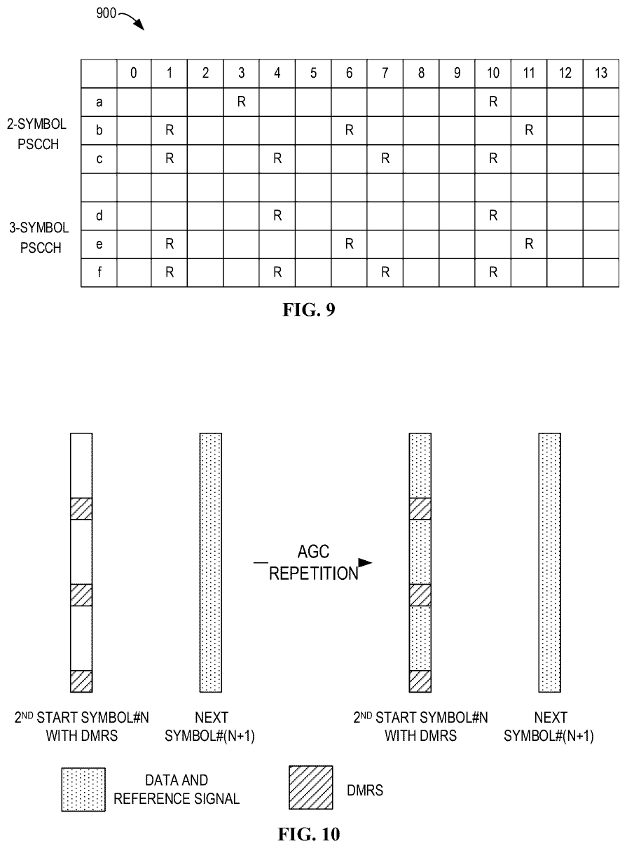

FIG. 9 illustrates a schematic diagram of resource occupation 900 in accordance with some other embodiments of the present disclosure. Specifically, the rows “a” to “f” show DMRS patterns, respectively. For purpose of discussion, a DMRS pattern corresponding to the row “a” is also referred to as “DMRS pattern a” hereafter.

In some embodiments, a UE/resource pool/Bandwidth part (BWP) may be configured or preconfigured with any proper second start symbol, for example, by a signaling from the higher layer (e.g., a RRC signaling). If the second start symbol is symbol 1, the terminal device 110 is not expected to use DMRS pattern b, c for 2-symbol PSCCH and DMRS pattern e, f for 3-symbol PSCCH. The DMRS pattern a may be used for 2-symbol PSCCH and pattern d may be used for 3-symbol PSCCH.

If the second start symbol is symbol 3, the terminal device 110 is not expected to use pattern a for 2-symbol PSCCH, and DMRS pattern b and c may be used for 2-symbol PSCCH and DMRS patterns d, e, and f may be used for 3-symbol PSCCH.

If the second start symbol is symbol 4, the terminal device 110 is not expected to use DMRS pattern c for 2-symbol PSCCH and pattern d, f for 3-symbol PSCCH. The DMRS patterns a and b may be used for 2-symbol PSCCH and DMRS pattern e may be used for 3-symbol PSCCH.

If the second start symbol is symbol 6, the terminal device 110 is not expected to use DMRS pattern b for 2-symbol PSCCH and DMRS pattern e for 3-symbol PSCCH. DMRS patterns a and c may be used for 2-symbol PSCCH and DMRS patterns d and f may be used for 3-symbol PSCCH.

If the second start symbol is symbol 7, the terminal device 110 is not expected to use DMRS pattern c for 2-symbol PSCCH and DMRS pattern f for 3-symbol PSCCH. DMRS patterns a and b may be used for 2-symbol PSCCH and DMRS patterns d and e may be used for 3-symbol PSCCH.

In some example embodiments, one of the at least one candidate position may be configured for automatic gain control (AGC) and DMRS transmission. The repetition from a next symbol for the AGC does not have any effect on the DMRS transmission.

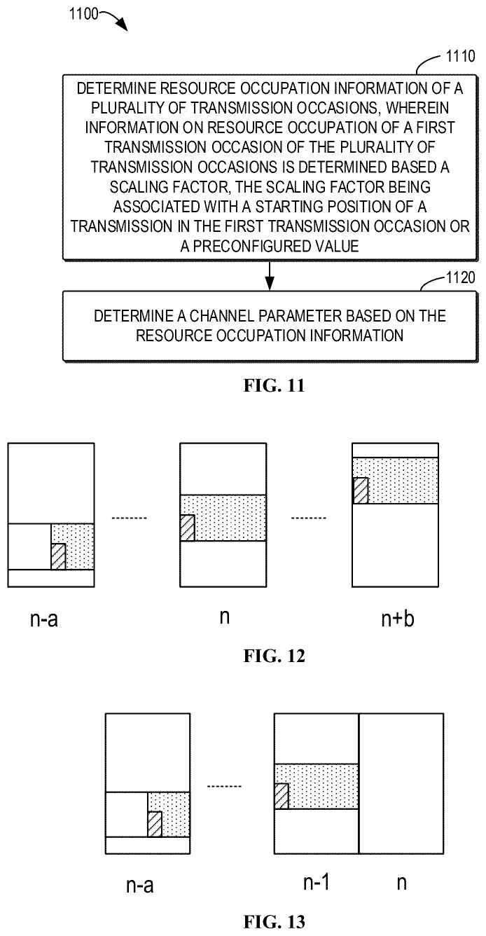

FIG. 10 illustrates a schematic diagram of AGC and DRMS transmission in accordance with some other embodiments of the present disclosure. As shown in FIG. 10, when the second (2^{nd}) start symbol is used for AGC and configured with DMRS, the repetition from next symbol to this second start symbol should not impact the DMRS resource element (RE).

In some situations, some channel parameters, such as a sidelink channel occupancy ratio (CR), a sidelink channel busy ratio (CBR), may need to be measured for slots with a transmission starting from the second start symbol. To solve this, embodiments of the present disclosure propose to add a scaling factor to adjust the counted sub-channels number for the transmission start from the second start symbol. More details of the embodiments will be discussed below.

FIG. 11 illustrates a flowchart of a communication method 1100 implemented at a first terminal device in accordance with some embodiments of the present disclosure. For the purpose of discussion, the method 1100 will be described from the perspective of the first terminal device 110 in FIG. 1.

At block 1110, the first terminal device 110 determines resource occupation information of a plurality of transmission occasions. Information on resource occupation of a first transmission occasion of the plurality of transmission occasions is determined based a scaling factor. The scaling factor may be associated with a starting position of a transmission in the first transmission occasion or a preconfigured value.

In some embodiments, the resource occupation information may comprise information on occupancy of subchannels.

At block 1120, the first terminal device 110 determines a channel parameter based on the resource occupation information.

In some example embodiments, the channel parameter may comprise a sidelink channel occupancy ratio (CR), a sidelink channel busy ratio (CBR) and/or the like.

FIG. 12 illustrates a schematic diagram of sidelink channel occupancy ratio (CR) measurement in accordance with some embodiments of the present disclosure. In the embodiments discussed with respect to FIG. 12, for the CR measurement, a scaling factor may be applied to the sub-channel number for transmissions start from the second start symbol.

In this case, Sidelink Channel Occupancy Ratio (SL CR) evaluated at slot n may be defined as the total number of sub-channels used for its transmissions in slots [n−a, n−1] and granted in slots [n, n+b] divided by the total number of configured sub-channels in the transmission pool over [n−a, n+b].

For the transmissions starting from the second (2nd) start symbol, a scaling factor f_CR may be applied to determine the number of sub-channels for CR evaluation. In some embodiments, the scaling factor f_CR may be determined by:

f_CR=symbol length from 2^{nd} start symbol to PSSCH end/symbol length from 1^{st} start symbol to PSSCH end

As an alternative, the scaling factor may be a configured value or a preconfigured value.

As shown in FIG. 12, the total number of sub-channels may be calculated by:

f_CR*[subchannel number in slot n−a]+[subchannel number in slot n]+[subchannel number in slot n+b]

FIG. 13 illustrates a schematic diagram of sidelink channel busy ratio (CBR) measurement in accordance with some embodiments of the present disclosure. In the embodiments discussed with respect to FIG. 12, for the CBR measurement, a scaling factor may be applied to the sub-channel number for transmissions start from 2^{nd} start symbol.

SL Channel Busy Ratio (SL CBR) measured in slot n may be defined as the portion of sub-channels in the resource pool whose SL RSSI measured by the UE exceed a (pre-)configured threshold sensed over a CBR measurement window [n−a, n−1], wherein a is equal to 100 or 100.24 slots, according to higher layer parameter sl-TimeWindowSizeCBR. When UE is configured to perform partial sensing by higher layers (including when SL DRX is configured), SL RSSI is measured in slots where the UE performs partial sensing and where the UE performs PSCCH/PSSCH reception within the CBR measurement window. The calculation of SL CBR is limited within the slots for which the SL RSSI is measured. If the number of SL RSSI measurement slots within the CBR measurement window is below a (pre-)configured threshold, a (pre-)configured SL CBR value is used.

For the transmissions start from the 2^{nd} start symbol, a scaling factor f_CBR may be applied to determine the number of sub-channels. In some embodiments, the scaling factor f_CBR may be determined by:

f_CBR=symbol length from 2^{nd} start symbol to the end of PSSCH duration/symbol length from 1st start symbol to the end of PSSCH duration

Alternatively, the scaling factor f_CBR may be a configured value or a preconfigured value.

For example, as shown in FIG. 13, if SL RSSI measured by the UE exceed a (pre-)configured threshold in slot n−a, the SL CBR may be determined based on f_CBR*[subchannel number in slot n−a]. Specifically, the resource occupation information of slot n−a is determined to be f_CBR*[subchannel number in slot n−a].

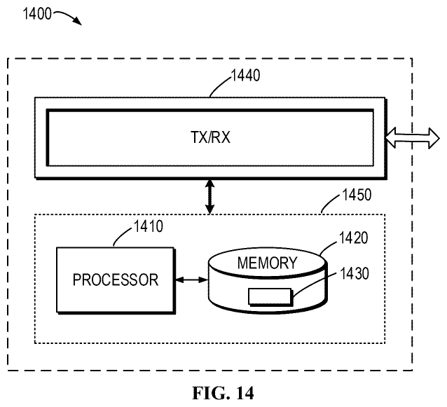

FIG. 14 is a simplified block diagram of a device 1400 that is suitable for implementing embodiments of the present disclosure. The device 1400 can be considered as a further example implementation of any of the devices as shown in FIG. 1. Accordingly, the device 1400 can be implemented at or as at least a part of the first terminal device 110 or the second terminal device 120.

As shown, the device 1400 includes a processor 1410, a memory 1420 coupled to the processor 1410, a suitable transmitter (TX)/receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a first terminal device comprises a circuitry configured to: performing, at a first terminal device, a first transmission of a transport block with a second terminal device, the first transmission starting from a first starting position; and performing a second transmission of the transport block with the second terminal device, the second transmission starting from a second starting position determined based on the first starting position. According to embodiments of the present disclosure, the circuitry may be configured to perform the method 300 implemented by the first terminal device as discussed above.

In some embodiments, a first terminal device comprises a circuitry configured to: determining, at a first terminal device, a starting position for a transmission of a transport block from a set of candidate positions, the set of candidate positions being determined based on a plurality of demodulation reference signal (DMRS) patterns for the transmission; and performing the transmission from the starting position. According to embodiments of the present disclosure, the circuitry may be configured to perform the method 600 implemented by the first terminal device as discussed above.

In some embodiments, a first terminal device comprises a circuitry configured to: determining, at a first terminal device, a target demodulation reference signal (DMRS) pattern from a group of DMRS patterns, the group of DMRS patterns being determined based on at least one candidate position for a transmission of a transport block between the first terminal device and the second terminal device; and performing the transmission based on the target DMRS pattern. According to embodiments of the present disclosure, the circuitry may be configured to perform the method 800 implemented by the first terminal device as discussed above.

In some embodiments, a first terminal device comprises a circuitry configured to: determining, at a first terminal device, resource occupation information of a plurality of transmission occasions, wherein information on resource occupation of a first transmission occasion of the plurality of transmission occasions is determined based a scaling factor, the scaling factor being associated with a starting position of a transmission in the first transmission occasion or a preconfigured value; and determining a channel parameter based on the resource occupation information. According to embodiments of the present disclosure, the circuitry may be configured to perform the method 1100 implemented by the first terminal device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In a first aspect, a method of communication is proposed. The method comprises: performing, at a first terminal device, a first transmission of a transport block with a second terminal device, the first transmission starting from a first starting position; and performing a second transmission of the transport block with the second terminal device, the second transmission starting from a second starting position determined based on the first starting position.

In some embodiments, the first starting position is a first candidate position, the second starting position is the first candidate position, or the first starting position is a second candidate position, the second starting position is the first candidate position or the second candidate position, wherein the first candidate position is prior to the second candidate position.

In some embodiments, the first transmission is an initial transmission of the transport block and the second transmission is a retransmission of the transport block, or the first transmission is a retransmission of the transport block and the second transmission is a further retransmission of the transport block.

In some embodiments, the method further comprises: determining a size of the transport block based on a time length from a second candidate position to the end of a transmission occasion.

In some embodiments, the method further comprises: determining a size of the transport block based on a time length from the first candidate position to the end of the transmission occasion excluding the second candidate position, the first starting position being a first candidate position prior to the second candidate position.

In some embodiments, the method further comprises: determining a size of the transport block based on a predetermined time length, the predetermined time length is an average value or a preconfigured value, the average value indicates an average of a first time length from the first candidate position to the end of the transmission occasion and a second time length from the second candidate position to the end of the transmission occasion.

In some embodiments, a difference between the first candidate position and the second candidate position is within a predefined range.

In some embodiments, if a time length of the second transmission is less than a time length of the first transmission, the second transmission is a punctured transmission.

In some embodiments, if a time length of the second transmission is larger than a time length of the first transmission, the second transmission is a rate matched transmission.

In some embodiments, if the first starting position is a second candidate position and the first transmission comprises a reservation indication, the reservation indication indicates a subsequent reserved resource for a third transmission starting from the first candidate position, and wherein the first candidate position is prior to the second candidate position.

In some embodiments, if the first starting position is a second candidate position, the first transmission does not have feedback from the second device, wherein a first candidate position is prior to the second candidate position.

In some embodiments, the first and second starting positions have a set of candidates comprising a first candidate position and a second candidate position, the first candidate position being prior to the second candidate position, and wherein a transmission staring from the second candidate position uses a second set of redundancy versions different from a first set of redundancy versions used by a transmission staring from the first candidate position.

In a second aspect, a method of communication is proposed. The method comprises: determining, at a first terminal device, a starting position for a transmission of a transport block from a set of candidate positions, the set of candidate positions being determined based on a plurality of demodulation reference signal (DMRS) patterns for the transmission; and performing the transmission from the starting position.

In some embodiments, the set of candidate positions comprise a candidate position indicating a symbol in a slot, an index of the symbol is 2 or 5.

In a third aspect, a method of communication is proposed. The method comprises: determining, at a first terminal device, a target demodulation reference signal (DMRS) pattern from a group of DMRS patterns, the group of DMRS patterns being determined based on at least one candidate position for a transmission of a transport block between the first terminal device and the second terminal device; and performing the transmission based on the target DMRS pattern.

In some embodiments, the group of DMRS patterns are determined by removing at least one DMRS pattern from a plurality of DMRS patterns, each of the at least one DMRS pattern having DMRS transmission in the at least one candidate position.

In some embodiments, one of the at least one candidate position is configured for automatic gain control (AGC) and DMRS transmission, the repetition from a next symbol for the AGC having no effect on the DMRS transmission.

In a fourth aspect, a method of communication is proposed. The method comprises: determining, at a first terminal device, resource occupation information of a plurality of transmission occasions, wherein information on resource occupation of a first transmission occasion of the plurality of transmission occasions is determined based a scaling factor, the scaling factor being associated with a starting position of a transmission in the first transmission occasion or a preconfigured value; and determining a channel parameter based on the resource occupation information.

In some embodiments, the channel parameter comprises at least one of a sidelink channel occupancy ratio (CR) or a sidelink channel busy ratio (CBR).

In a fifth aspect, a first terminal device is proposed. The first terminal device comprises: at least one processor; and at least one memory coupled to the at least one processor and storing instructions thereon, the instructions, when executed by the at least one processor, causing the device to perform the method implemented by the first terminal device discussed above.

In a sixth aspect, a computer readable medium having instructions stored thereon, the instructions, when executed on at least one processor, causing the at least one processor to perform the method implemented by the first terminal device discussed above.

In a seventh aspect, a computer program comprising instructions, the instructions, when executed on at least one processor, causing the at least one processor to perform the method implemented by the first terminal device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a terminal device, comprising:
receiving configuration information comprising a first number of symbols for transport block size (TBS) determination; and
determining TBS based on the first number of symbols, in a case where two starting symbols for a Physical Sidelink Control Channel (PSCCH)/Physical Sidelink Shared Channel (PSSCH) transmission within a slot are provided.

22. The method of claim 21, wherein the two starting symbols are in the slot without Physical Sidelink Feedback Channel (PSFCH) symbols.

23. The method of claim 22, wherein the two starting symbols in the slot comprises a first starting symbol and a second starting symbol, and the second starting symbol is later than the first starting symbol,
wherein Channel Busy Ratio (CBR) measured in a slot is defined as portion of sub-channels in a resource pool whose sidelink received signal strength indicator (SL RSSI) measured by the terminal device exceed a threshold sensed over a CBR measurement window, and measurement of the SL RSSI is based on the second starting symbol.

24. A terminal device, comprising a processor configured to:
receive configuration information comprising a first number of symbols for transport block size (TBS) determination; and
determine TBS based on the first number of symbols, in a case where two starting symbols for a Physical Sidelink Control Channel (PSCCH)/Physical Sidelink Shared Channel (PSSCH) transmission within a slot are provided.

25. The terminal device of claim 24, wherein the two starting symbols are in the slot without Physical Sidelink Feedback Channel (PSFCH) symbols.

26. The terminal device of claim 25, wherein the two starting symbols in the slot comprises a first starting symbol and a second starting symbol, and the second starting symbol is later than the first starting symbol,
wherein Channel Busy Ratio (CBR) measured in a slot is defined as portion of sub-channels in a resource pool whose sidelink received signal strength indicator (SL RSSI) measured by the terminal device exceed a threshold sensed over a CBR measurement window, and measurement of the SL RSSI is based on the second starting symbol.
